(19) United States
(12) Patent Application Publication
(10) Pub. No.: US 2007/0116611 A1
(43) Pub. Date: May 24, 2007

(54) FRACTION COLLECTION SYSTEM

(76) Inventor: Nicholas DeMarco, Burlington, WI (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/559,864

(22) Filed: Nov. 14, 2006

Related U.S. Application Data
(60) Provisional application No. 60/736,448, filed on Nov. 14, 2005.

(51) Int. Cl. B01L 11/00

(52) U.S. Cl. 422/101; 210/198.2; 422/70; 422/63

(57) ABSTRACT

A fraction collection system includes a fraction collector having a frame, an adapter tray configured to slide between a first position and a second position with respect to the frame, and a collection rack configured to support at least one receptacle, the collection rack movable with respect to the frame between the first position and the second position.

### RELATED APPLICATIONS

This patent application claims the benefit of U.S. provisional patent application Ser. No. 60/736,448 filed on Nov. 14, 2005.

### BACKGROUND

Chromatography is one example of an analytical chemistry system that can employ a fraction collection system. Chromatography is used to analyze the constituents, or fractions, of a sample of interest, and, in some cases, to collect each of the fractions of the sample of interest separately for further analysis or use. Chromatography generally relates to any of a variety of techniques used to separate complex mixtures based on the differential affinities of the fractions of the sample for a mobile phase with which the sample flows, and a stationary phase through which the sample passes.

Generally, liquid chromatography includes a stationary phase that includes a finely powdered solid adsorbent packed into a chromatography cartridge or column, and the mobile phase includes one or more eluting solvents that are moved through the cartridge by a pump. The sample to be analyzed by liquid chromatography is injected into the cartridge and monitored by a detector. The detector provides identification and/or differentiation of the fractions as the fractions elute from the cartridge. One type of liquid chromatography, flash chromatography, includes a cartridge (in some cases, a disposable cartridge) filled with the stationary phase (e.g., silica gel), and the sample to be separated is placed on top of the stationary phase. The cartridge is filled with an isocratic or gradient solvent which, with the help of pressure, enables the sample to run through the cartridge and become separated. Liquid chromatography, and particularly, flash chromatography can be used for a variety of applications, including, but not limited to, drug discovery, sample clean-up, and natural product purification, among others.

### SUMMARY

The present invention relates to a fraction collection system for use in the field of chemistry, and particularly, for use in the field of analytical chemistry. Fraction collection systems can be used to separate and collect the constituents, or fractions, of a variety of samples. Fraction collection systems can be used to produce an end product, or an intermediate product that can be further manipulated, investigated, or analyzed. Fraction collection systems can be used to aliquot a larger volume of fluid into multiple smaller volumes of fluids, such that each fraction includes the same chemical makeup as the other fractions. In addition, fraction collection systems can be used to collect fractions of a sample that have been identified and separated (e.g., by an upstream process, such as a chromatography process) as having a different chemical makeup.

In one embodiment, the invention provides a fraction collection system operable with an analytical chemistry system. The fraction collection system includes a first fraction collector having a frame, an adapter tray configured to slide between a first position and a second position with respect to the frame, and a collection rack configured to support at least one receptacle. The collection rack is movable with respect to the frame between the first position and the second position.

In another embodiment, the invention provides a fraction collection system configured for chromatography processes. The fraction collection system includes a first fraction collector having a first frame, a first adaptor tray that slides with respect to the first frame, and a first collection rack supported by the first adaptor tray. The fraction collection system also includes a second fraction collector having a second frame, a second adaptor tray that slides with respect to the second frame, and a second collection rack supported by the second adaptor tray. The first fraction collector is coupled to the second fraction collector for performing chromatography processes in at least one of the first fraction collector and the second fraction collector.

Other aspects of the invention will become apparent by consideration of the detailed description and accompanying drawings.

### BRIEF DESCRIPTION OF THE DRAWINGS

FIG. 1 is a perspective view of a fraction collection system according to one embodiment of the present invention, including a plurality of stackable fraction collectors.

FIG. 2 is a perspective view of a portion of one of the stackable fraction collectors.

FIG. 3 is a perspective view of an adapter tray of one of the stackable fraction collectors.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “supported,” and “coupled” and variations thereof are used broadly and encompass both direct and indirect mountings, connections, supports, and couplings. Further, “connected” and “coupled” are not restricted to physical or mechanical connections or couplings, but can include, for example, electrical and fluid connections or couplings.

Although directional references, such as upper, lower, downward, upward, rearward, bottom, front, rear, etc., may be made herein in describing the drawings, these references are made relative to the drawings (as normally viewed) for convenience. These directions are not intended to be taken literally or limit the present invention in any form. In addition, terms such as “first”, “second”, and “third” are used herein for purposes of description and are not intended to indicate or imply relative importance or significance.

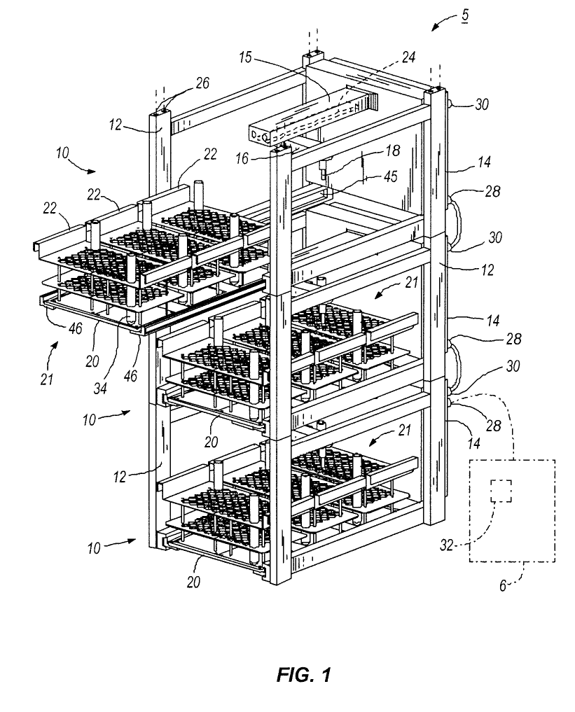

FIG. 1 illustrates a fraction collection system 5 according to one embodiment of the present invention. By way of example only, the fraction collection system 5 illustrated in FIG. 1 is shown as being coupled to a chromatography system 6. However, it should be understood that the fraction collection system 5 of the present invention can be used with a variety of other systems, including other chemistry systems, such as other analytical chemistry systems.

The fraction collection system 5 can include one or more stackable fraction collectors 10. In the embodiments illustrated in FIG. 1, the fraction collection system 5 includes three stackable fraction collectors 10. However, three fraction collectors 10 are illustrated in FIG. 1 by way of example only to illustrate their stackable nature. It should be understood that the actual number of fraction collectors 10 in any given fraction collection system 5 can vary (i.e., can be more or less than three). Each fraction collector 10 of the illustrated embodiment includes a frame 12, a controller 14, a first arm 15 having a track 24 defined therein, a second arm 16 movable with respect to the first arm 15 via the track 24, a nozzle 18 coupled to the second arm 16, and an adapter tray 20 that supports a collection rack assembly 21. Each collection rack assembly 21 can include one or more collection racks 22.

The frame 12 can be formed of a variety of materials, including, without limitation, at least one of metal, plastic, ceramic, a composite material, or any other suitable material. The frame 12 supports the first arm 15 and the second arm 16 near the top of the fraction collector 10, and supports the adapter tray 20 near the bottom. The frame 12 can include any of a variety of structures, such as protrusions, recesses, or combinations thereof to allow the fraction collectors 10 to be stacked by inter-engagement of such structures. For example, in some embodiments, as shown in FIG. 1, the top of the frame 12 includes protrusions 26 and the bottom of the frame 12 includes complementary recesses (not shown) to secure the frames 12 with respect to one another when stacked. The stackability and modularity of the fraction collectors 10 of the fraction collection system 5 allows the entire fraction collection system 5 to consume less total area of highly valuable floor or lab-bench space than if the fraction collectors 10 were arranged on the same support surface (e.g., side-by-side).

In some embodiments of the present invention, the fraction collection system 5 includes a controller 14 adapted to control the one or more fraction collectors 10. In some embodiments, as shown in the illustrated embodiment, each fraction collector 10 includes a dedicated controller 14. The controller 14, whether dedicated or universal, provides instructions to control the motion of the second arm 16 of each fraction collector 10 to control the separation and collection of fractions of a sample of interest. In embodiments employing dedicated controllers 14, as shown in FIG. 1, each controller 14 includes an input connection 28 and an output connection 30. The input connection 28 allows the controller 14 to receive instructions based on the chromatography analysis being performed. These instructions may come from a variety of suitable sources of instruction, including, but not limited to, a controller or microprocessing unit 32, which may be a part of, or used in conjunction with, the chromatography system 6, or any other suitable sources of instruction. The output connection 30 allows fraction collectors 10 to be connected in a series configuration by passing instructions to the input connection 28 on another fraction collector 10. This permits single large chromatography processes to be run across multiple fraction collectors 10 if the number of fractions to be collected exceeds the number of receptacles 34 allocated to one fraction collector 10. As a result, the fraction collection system 5 may be used to continuously run an infinitely long fraction collection process (e.g., a chromatography process) with as few as two fraction collectors 10, provided a user replaced the collection racks 22 as they became full and the corresponding fraction collector 10 became temporarily inactive. As a result, the fraction collection system 5 is configurable to match the capacity desired for any given fraction collection process.

In some embodiments, the fraction collectors 10 of the fraction collection system 5 are connected in parallel so that different tests can be run simultaneously using the individual fraction collectors 10 of one fraction collection system 5. In such embodiments, each fraction collector 10 will receive its own set of instructions to the input connection 28 on the controller, rather than receiving instructions from the output connection 30 of another fraction collector 10. Some embodiments of the present invention can include a combination of fraction collectors 10 connected in series and fraction collectors 10 connected in parallel.

The nozzle 18 can be fluidly coupled to a detector (e.g., a UV detector) of the chromatography system 6. The fractions of a sample of interest can be separated by passage through one or more chromatography cartridges, identified by a detector, and sent to the fraction collection system 5 to be collected. The fractions can be sent to any nozzle 18 of the fraction collection system 5, or to waste, as instructed by a user or peak detection software (also sometimes referred to as fraction collection software). The controller 14 can include at least rudimentary peak detection software, and/or the controller 14 can be adapted to receive instructions from external peak detection software of the chromatography system 6. When a fraction is sent to a nozzle 18, the controller 14 operates the second arm 16 to move the nozzle 18 to a position above a desired receptacle 34.

As shown in FIG. 1, a first end of the first arm 15 is coupled to an upper portion of the frame 12, and a second end of the first arm 15 is cantilevered over the collection rack assembly 21. The nozzle 18 is coupled to a first end of the second arm 16. The nozzle 18 is directed downwardly and is adapted to dispense collected fractions into receptacles 34. A second end of the second arm 16, opposite the first end, is coupled to the first arm 15, and particularly, to the track 24 defined by the first arm 15. To access all of the receptacles 34 in a collection rack 22, the second arm 16 is rotationally and translationally movable relative to the first aim 15 in a polar coordinate system. To accomplish this, the length of the track 24 can be greater than the length of the second arm 16. The controller 14 can receive r and θ coordinates (e.g., from the controller 32) corresponding to the location of a destination receptacle 34 for a given fraction, and the controller 14 can activate the second arm 16 (e.g., via activation of a motor) to move relative to the first arm 15 accordingly. The second arm 16 can be moved in a linear direction along the track 24, and can also pivot about a connection point between the first arm 15 and the second arm 16. As a result, the nozzle 18 can be positioned above any desired receptacle 34 by a combination of translational and/or rotational motions. A variety of coordinate systems can be employed to control the movement of the nozzle 18 relative to the receptacles 34. For example, other embodiments of the present invention may include a two or three dimensional Cartesian coordinate system for positioning the nozzle 18 over a desired receptacle 34 for expulsion of one or more fractions.

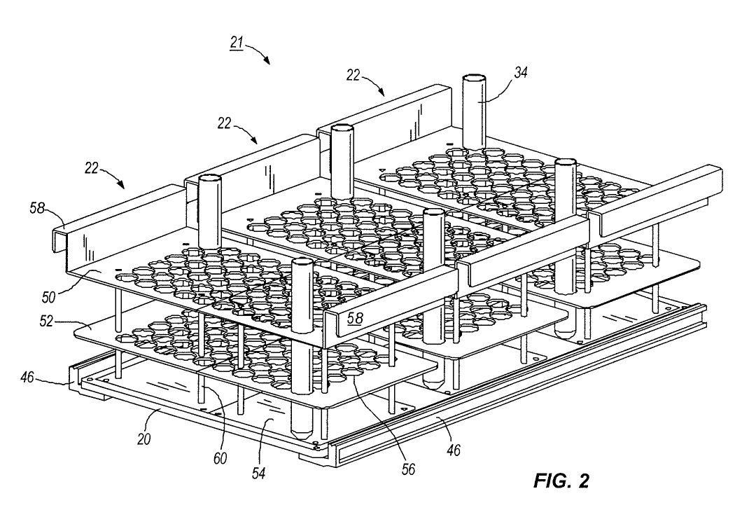

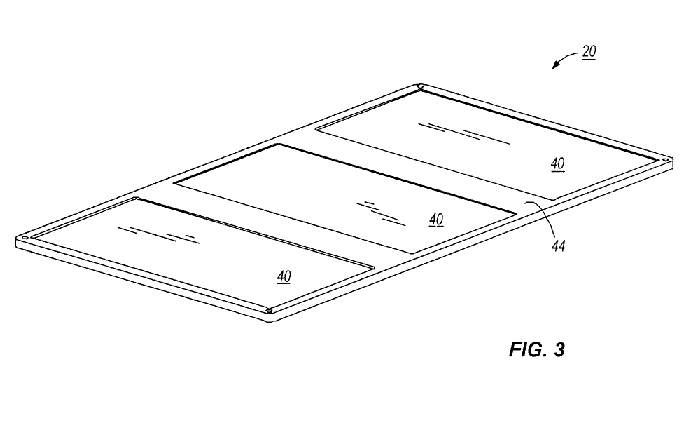

Referring to FIG. 3, the adapter tray 20 is generally flat and includes an upper surface 44 that defines one or more recesses 40. The adapter tray 20 can be formed of a variety of materials, including, but not limited to, at least one of metal, ceramic, plastic, a composite material, or any other suitable material. As shown in FIG. 2, the collection rack assembly 21 includes three collection racks 22. Accordingly, the adapter tray 20 includes three recesses 40, each dimensioned to receive a collection rack 22. Other embodiments of the adapter tray 20 may include any variety and combination of recesses, protrusions, apertures, demarcations, sensors, and the like, to accommodate one or more collection racks 22 from different manufacturers. That is, the adapter tray 20 can be removable and replaceable to allow other adapter trays to be used with the fraction collection system 5 that are adapted to hold other collection racks 22 of a different configuration. As a result, the fraction collection system 5 can be configured to be used with any manufacturer's collection racks 22. In some embodiments, the fraction collection system 5 can be packaged as a kit with customer-specific adapter tray(s) 20. In other embodiments, the fraction collection system 5 can come equipped with a variety of adapter trays 20 to allow a user to adapt his/her fraction collection system 5 as he/she desires. In still other embodiments, the fraction collection system 5 can include a single adapter tray 20 with a variety of recesses, protrusions, apertures, demarcations, sensors, and the like, to allow the single adapter tray 20 to be used to support a multitude of different collection racks 22 from different manufacturers.

In some embodiments, each adapter tray 20 is stationary with respect to the frame 12 and supports the collection rack assembly 21. However, in some embodiments, as shown in FIGS. 1 and 2, the adapter tray 20 is slidable with respect to the frame 12 (e.g., similar to a drawer) to facilitate the observation of samples, the removal or exchange of collection racks 22, and/or the removal or exchange of receptacles 34. The collection rack assembly 21 of the top fraction collector 10 illustrated in FIG. 1 is shown as being slid out into a “setup” position, while the collection rack assemblies 21 of the other two fraction collectors 10 illustrated in FIG. 1 are shown in an “operating” position. The slidable nature of the adapter tray 20 into the “setup” position facilitates access of any portion of the collection rack assembly 21, while still allowing the collection rack assembly 21 to be supported by the frame 12 of the fraction collector 10. In other words, the slidability of the adapter tray 20 facilitates access of the collection rack assembly 21 without requiring that the collection rack assembly 21 be removed and held or placed upon another support surface. As a result, the slidability of the adapter tray 20 of each fraction collector 10 provides an additional space-saving mechanism, such that each fraction collector 10 takes up less valuable floor or lab-bench space than if the collection rack assembly 21 had to be removed, in part or in whole, from each fraction collector 10. The “operating ” position allows the collection rack assembly 21 to be ready to receive fractions of a sample of interest during operation of the fraction collector 10.

In some embodiments, as shown in the illustrated embodiment, the frame 12 includes one or more tracks 45 dimensioned to receive at least a portion of the adapter tray 20 to allow the adapter tray 20 to slide relative to the frame 12. In some embodiments, as shown in FIGS. 1 and 2, the fraction collector 10 can include a sliding mechanism 46 coupled to two opposing sides of the adapter tray 20 and dimensioned to be received within the tracks 45 of the frame 12 to allow the adapter tray 20 to slide in and out of the frame 12 below the first and second arms 15, 16, and the nozzle 18. In some embodiments, the sliding mechanism 46 can be adapted to inhibit the complete removal of the adapter tray 20 from the frame 12 to prevent dropping the adapter tray 20 or the collection rack assembly 21. In some embodiments, each fraction collector 10 includes a plurality of independently slidable adapter trays 20, such that a portion of the collection rack assembly 21 can be accessed, removed and/or exchanged without disturbing the other portions of the collection rack assembly 21 or a fraction collection process. In such embodiments, the fraction collector 10 may be used to continuously run an infinitely long chromatography process with as few as two independently slidable adapter trays 20, provided a user replaced the collection racks 22 (or portions thereof) corresponding to each slidable adapter tray 20 as they became full.

The sliding mechanism 46 is shown in the illustrated embodiment by way of example only. Other embodiments may employ other types of sliding mechanisms, such as an ACCURIDE®-brand drawer slide (e.g., Model No. 2907, available from Accuride International Inc., Santa Fe Springs, Calif.).

The collection rack assembly illustrated in FIG. 2 includes three identical collection racks 22. Each collection rack 22 includes an upper divider 50, a lower divider 52, and a base plate 54. As shown in FIG. 2, the recesses 40 of the adapter tray 20 are slightly larger than the perimeter of the base plate 54, such that each collection rack 22 can be positioned in a recess 40 of the adapter tray 20. Each collection rack 22 of the illustrated embodiment includes a plurality of apertures 56, and each aperture 56 is dimensioned to receive a receptacle 34. In the illustrated embodiment, the upper and lower dividers 50, 52 have sixty uniformly sized and spaced apertures 56 dimensioned to receive sixty test tubes, respectively. The number and position of the apertures 56 in each collection rack 22 can vary, depending on the shape and size of the receptacles 34 used. The apertures 56 of the illustrated embodiment are shown by way of example only, and any suitable receptacle holding means can be employed to hold each receptacle 34 in the collection rack 22. For example, recesses, grooves, or depressions can also be employed to receive and hold the receptacles 34 in the collection rack 22.

The base plate 54 supports the receptacles 34, and is shaped and dimensioned to fit within one of the recesses 40 on the adapter tray 20 to inhibit the collection racks 22 from moving or shifting with respect to the adapter tray 20. The upper dividers 50 also include handles 58 to allow a user to grasp the collection rack 22 during placement or removal of the collection rack 22 from the adapter tray 20. The upper divider 50, lower divider 52, and base plate 54 are coupled together and held at a constant distance from each other via standoffs 60. The standoffs 60 are sufficiently rigid to resist shifting or rotating of the upper and lower dividers 50, 52 with respect to one another to maintain the receptacles 34 in a substantially vertical orientation. The collection racks 22 shown in the illustrated embodiment are shown by way of example only, and those of ordinary skill in the art should appreciate that the fraction collection system 5 is flexible to accommodate a variety of configurations, sizes and quantities of collection racks 22.

Various features and advantages of the invention are set forth in the following claims.

What is claimed is:

1. A fraction collection system comprising:
a first fraction collector including
a frame,
an adapter tray configured to slide relative to the frame,
a collection rack supported by the adapter tray and configured to support at least one receptacle,
a first arm coupled to the frame,
a second arm coupled to the first arm and adapted to move relative to the first arm, and
a first controller supported by the frame, the controller including an input connection and an output connection, and operable to control motion of the second arm.

2. The fraction collection system of claim 1, further comprising a second fraction collector configured to be vertically stackable relative to the first fraction collector, the second fraction collector including a second controller.

3. The fraction collection system of claim 2, wherein the second fraction collector is configured to be connected in a series configuration with the first fraction collector to run the same chromatography process with the first fraction collector and the second fraction collector.

4. The fraction collection system of claim 3, wherein the second controller comprises an output connection and wherein the output connection of the second controller is coupled to the input connection of the first controller.

5. The fraction collection system of claim 2, wherein the second fraction collector is connected to the first fraction collector in a parallel configuration.

6. The fraction collection system of claim 1, wherein the adapter tray is movable between a first position and a second position, and wherein the first position is a setup position and the second position is an operating position, and wherein at least one of the setup position and the operating position is configured for at least one of observation of samples of the fraction collection system, removal and exchange of the collection rack, and removal and exchange of the receptacle.

7. The fraction collection system of claim 1, wherein the adapter tray further includes a receptacle configured to receive a plate of the collection rack for supporting the collection rack and moving the collection rack with respect to the frame.

8. The fraction collection system of claim 1, further comprising a nozzle coupled to the second arm, the nozzle operable to selectively distribute a fraction to the receptacle positioned in the collection rack.

9. The fraction collection system of claim 8, wherein the second arm is movable with respect to the first arm in at least one of a translational motion and a rotational motion to selectively move the nozzle to the receptacle.

10. The fraction collection system of claim 1, wherein the input connection of the first controller is operable to receive instructions from a chromatography system

11. The fraction collection system of claim 10, wherein the first controller moves the second arm according to instructions from the chromatography system and being based on a chromatography analysis being performed.

12. The fraction collection system of claim 1, further comprising a nozzle coupled to the second arm and fluidly connected to a detector of a chromatography system.

13. A fraction collection system configured for chromatography processes, the fraction collection system comprising:
a first fraction collector including
a first frame,
a first adapter tray slidable with respect to the first frame,
a first arm coupled to the first frame,
a second arm coupled to the first arm and movable with respect to the first arm,
a first nozzle coupled to the second arm, and
a first collection rack supported by the first adapter tray, and
a second fraction collector including
a second frame,
a second adapter tray slidable with respect to the second frame,
a third arm coupled to the second frame,
a fourth arm coupled to the third arm and movable with respect to the third arm,
a second nozzle coupled to the fourth arm, and
a second collection rack supported by the second adapter tray,
the first frame of the first fraction collector coupled to the second frame of the second fraction collector, the first fraction collector and the second fraction collector adapted to receive a plurality of samples usable in a chromatography process.

14. The fraction collection system of claim 13, further comprising
a first controller supported by the first frame and configured to control the first fraction collector, the first controller including a first input connection and a first output connection, and
a second controller supported by the second frame and configured to control the second fraction collector, the second controller including a second input connection and a second output connection.

15. The fraction collection system of claim 14, wherein the first controller is connected to the second controller in a series configuration to operate the first fraction collector and the second fraction collector to perform the same chromatography process in the first fraction collector and the second fraction collector.

16. The fraction collection system of claim 15, wherein the input connection of the first controller is connected to the output connection of the second controller, and the input connection of the second controller is connected to a processor configured to generate instructions related to the chromatography process.

17. The fraction collection system of claim 14, wherein the first controller is connected to the second controller in a parallel configuration.

18. The fraction collection system of claim 17, wherein the first fraction collector is configured to perform a first chromatography process and the second fraction collector is configured to perform a second chromatography process, the first chromatography process and the second chromatography process being performed at substantially the same time.

19. The fraction collection system of claim 13, wherein the second arm is operable to move in at least one of a translational motion and a rotational motion with respect to the first arm to selectively move the first nozzle to a first receptacle.

20. The fraction collection system of claim 19, wherein the fourth arm is operable to move in at least one of a translational motion and a rotational motion with respect to the third arm to selectively move the second nozzle to a second receptacle, the fourth arm operable to move independently from the second arm.
